(19) United States
(12) Patent Application Publication
(10) Pub. No.: US 2024/0354970 A1
(43) Pub. Date: Oct. 24, 2024

(54) REASONING METHOD, REASONING SYSTEM, AND REASONING PROGRAM

(71) Applicant: NIPPON TELEGRAPH AND TELEPHONE CORPORATION, Tokyo (JP)

(72) Inventors: Kyoku SHI, Musashino-shi, Tokyo (JP); Takeharu EDA, Musashino-shi, Tokyo (JP); Akira SAKAMOTO, Musashino-shi, Tokyo (JP); Shohei ENOMOTO, Musashino-shi, Tokyo (JP); Ichiro MORINAGA, Musashino-shi, Tokyo (JP)

(73) Assignee: NIPPON TELEGRAPH AND TELEPHONE CORPORATION, Tokyo (JP)

(21) Appl. No.: 18/579,870

(22) PCT Filed: Jul. 21, 2021
(86) PCT No.: PCT/JP2021/027406

§ 371 Date: Jan. 17, 2024

(51) Int. Cl. G06T 7/292

(52) U.S. Cl. CPC G06T 7/292; G06T 2207/20076; G06T 2207/30196

(57) ABSTRACT

In an inference system including an edge and a server, an acquisition unit acquires information regarding movement of a predetermined subject imaged by a first camera among cameras on the edge at least at a first time point. An estimation unit estimates a second camera that images the predetermined subject at a second time point later than the first time point on the basis of a movement destination of the predetermined subject.

### TECHNICAL FIELD

The present invention relates to an inference method, an inference system, and an inference program.

### BACKGROUND ART

In recent years, real-time applications using deep neural networks (DNNs) such as video monitoring, voice assistants, and automated driving have appeared. Such real-time applications are required to process large amounts of queries in real time with limited resources while maintaining accuracy of the DNNs. Thus, a technology called model cascading that can speed up inference processing with little degradation in accuracy by using a lightweight model, which is high-speed and low-accuracy, and a high-accuracy model, which is low-speed and high-accuracy, has been proposed.

In the model cascading, a plurality of models including a lightweight model and a high-accuracy model are used. When inference is executed by the model cascading, estimation is first executed with the lightweight model, and if the result is reliable, the result is adopted and the processing is ended. On the other hand, if the result of inference with the lightweight model is not reliable, inference is subsequently executed with the high-accuracy model, and the result is adopted. For example, an “I Don't Know” (IDK) cascade (see, for example, Non Patent Literature 1) is known in which an IDK classifier is introduced to determine whether a result of inference with a lightweight model is reliable.

### CITATION LIST

### Non Patent Literature

Non Patent Literature 1: Wang, Xin, et al., “Idk cascades: Fast deep learning by learning not to overthink”, arXiv preprint arXiv: 1706.00885 (2017).

### SUMMARY OF INVENTION

### Technical Problem

However, in the technique described in Non Patent Literature 1, inference is not examined, and learning is based on an idea obtained from fine tuning, and thus the technique is based on an assumption that learning for the same purpose is performed. In addition, since it is assumed that all of a large number of pieces of sensor data are processed, there still remains problems regarding the amount of transmission from a sensor to an edge and from the edge to a cloud and the total computation amount of the edge and the cloud.

The present invention has been made in view of the above, and an object thereof is to track a subject by efficiently performing inference with two layers, an edge layer and a cloud layer.

### Solution to Problem

In order to solve the above-described problems and achieve the object, the present invention provides an inference method executed by an inference system including an edge and a server, the inference method including: an acquisition process of acquiring information regarding movement of a predetermined subject imaged by a first camera among cameras on the edge at least at a first time point; and an estimation process of estimating, from acquired videos, a second camera that images the predetermined subject at a second time point later than the first time point on a basis of a movement destination of the predetermined subject.

### Advantageous Effects of Invention

According to the present invention, it is possible to track a subject by efficiently performing inference with two layers, an edge layer and a cloud layer.

### BRIEF DESCRIPTION OF DRAWINGS

FIG. 1 is a diagram for illustrating an outline of an inference system of the present embodiment.

FIG. 2 is a schematic diagram illustrating a schematic configuration of the inference system of the present embodiment.

FIG. 3 is a diagram for illustrating processing by an estimation unit.

FIG. 4 is a flowchart illustrating an inference processing procedure.

FIG. 5 is a diagram for illustrating an effect of processing.

FIG. 6 is a diagram for illustrating the effect of the processing.

FIG. 7 is a diagram illustrating an example of a computer that executes an inference program.

### DESCRIPTION OF EMBODIMENTS

Hereinafter, an embodiment of the present invention will be described in detail with reference to the drawings. Note that the present invention is not limited by this embodiment. In the description of the drawings, the same portions are denoted by the same reference numerals.

### Outline of Inference System

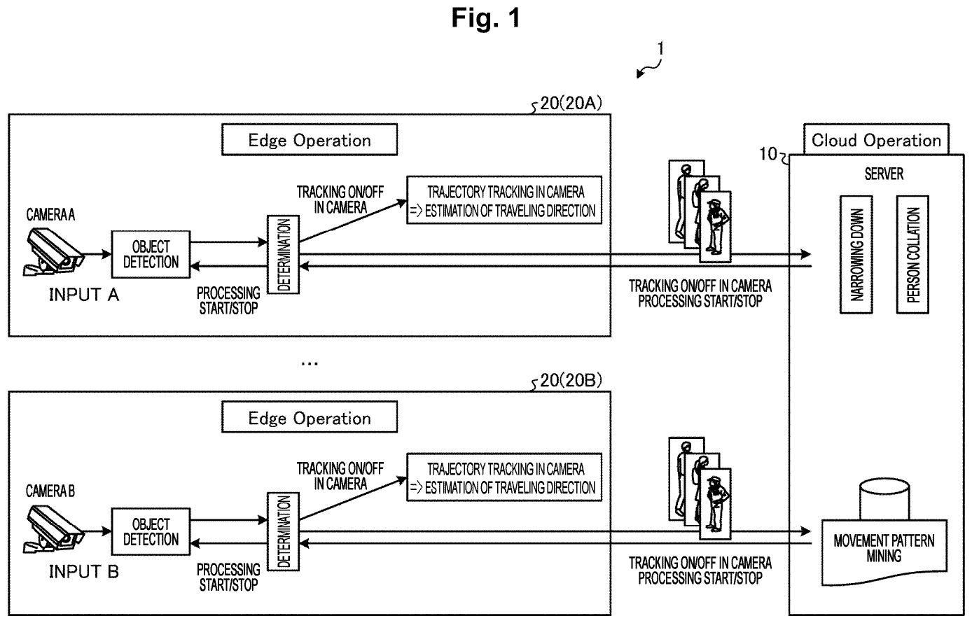

FIG. 1 is a diagram for illustrating an outline of an inference system of the present embodiment. An inference system 1 of the present embodiment includes cameras 20 as an example of IoT equipment on an edge side and a server 10 on a cloud side. In the inference system 1, the server 10 estimates a camera 20 that satisfies a predetermined requirement, and performs desired inference by using a video and information acquired from the estimated camera 20.

For example, as illustrated in FIG. 1, the inference system 1 is applied to tracking a person. That is, the server 10 collates and identifies a person to be tracked. In addition, the server 10 estimates a camera 20 that can image the identified person on the basis of the positions of all the cameras, and instructs only the estimated camera 20 to perform tracking.

The camera 20 estimated by the server 10 detects the identified person from a video being captured and executes tracking for estimating a traveling direction. When the person moves out of a range that can be imaged by the camera 20, the camera 20 notifies the server 10 so that the person is tracked by the server 10.

Specifically, as illustrated in FIG. 1, the server 10 collates and identifies a person to be tracked, estimates a camera 20 that can image the identified person as a predetermined subject, and instructs only the estimated camera 20 (20A) to track the identified subject.

The camera 20 (20A) that is imaging the subject detects the subject, computes the speed thereof, and estimates the traveling direction. Furthermore, the camera 20 (20A) notifies the server 10 when the subject moves out of the range where imaging is possible. The server 10 estimates a possibility for the next camera 20 that can image the subject on the basis of results of analyzing a flow of people such as the speed and the traveling direction of the subject and a movement pattern, of which the camera 20 (20A) has notified the server 10, and the positions of the cameras 20, and then instructs the estimated camera 20 (20B) to detect and track the subject.

This allows the inference system 1 to efficiently track a desired person. In this manner, the inference system can efficiently perform desired inference and track a subject by reducing the data transmission amount and the total computation amount of inference processing with two layers, an edge layer and a cloud layer.

Note that targets of processing by the inference system 1 are not limited to videos. For example, it is also possible to use acoustic signals as targets and estimate and track a sound source position and a sound source direction.

### Configuration of Inference System

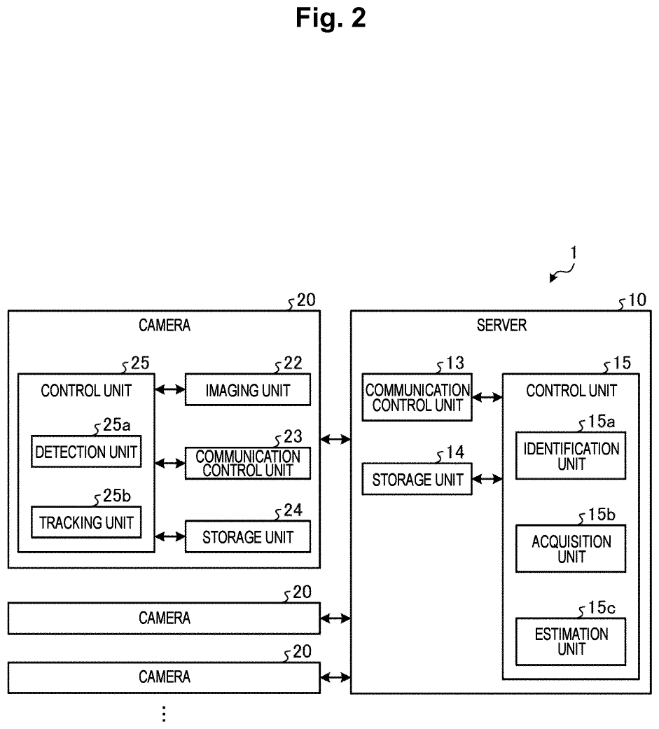

FIG. 2 is a schematic diagram illustrating a schematic configuration of the inference system of the present embodiment. As illustrated in FIG. 2, the inference system 1 of the present embodiment includes the cameras 20 as an example of IoT equipment on the edge side and the server 10 on the cloud side.

### Configuration of Camera

The camera 20 includes an imaging unit 22, a communication control unit 23, a storage unit 24, and a control unit 25. The imaging unit 22 acquires a video by continuously imaging an imaging range of the camera 20 that includes the imaging unit 22.

The communication control unit 23 is implemented by a network interface card (NIC) or the like, and controls communication between an external device and the control unit 25 via a telecommunication line such as a local area network (LAN) or the Internet. For example, the communication control unit 23 controls communication between the server 10 or the like and the control unit 25.

The storage unit 24 is implemented by a semiconductor memory element such as a random access memory (RAM) or a flash memory, or a storage device such as a hard disk or an optical disc. In the storage unit 24, a processing program for operating the camera 20, data to be used during execution of the processing program, and the like are stored in advance or temporarily stored each time processing is performed. In the present embodiment, the storage unit 24 stores, for example, a model for classifying videos used for processing by a detection unit 25a to be described later.

The control unit 25 is implemented by a central processing unit (CPU), a network processor (NP), a field programmable gate array (FPGA), or the like, and functions as the detection unit 25a and a tracking unit 25b by executing a processing program stored in a memory.

The detection unit 25a detects a person in a video being captured by the imaging unit 22, and assigns a rectangle ID to a rectangle that includes the person. Furthermore, in a case where an instruction has been given from the server 10 to be described later, the detection unit 25a transmits an image obtained by cropping the rectangle to the server 10.

In a case where an instruction to track an identified person has been given from the server 10 to be described later, the tracking unit 25b computes a moving speed of the identified person and estimates a traveling direction. For example, in a case where the server 10 has notified the tracking unit 25b of the rectangle ID of the identified person, the tracking unit 25b computes the speed of the person and estimates the traveling direction of the person by tracking a trajectory of the rectangle that includes the person.

Then, at a timing when the person moves out of the imaging range of the camera 20 that includes the tracking unit 25b, the tracking unit 25b transmits a camera ID, the rectangle ID, the speed, and the estimated traveling direction to the server 10 via the communication control unit 23. Instead of the rectangle ID, coordinates of a BBOX or the like may be used to identify the rectangle that includes the person and transmitted to the server 10.

### Configuration of Server

The server 10 is implemented by a general-purpose computer such as a personal computer, and includes a communication control unit 13, a storage unit 14, and a control unit 15.

The communication control unit 13 is implemented by a network interface card (NIC) or the like, and controls communication between an external device and the control unit 15 via a telecommunication line such as a local area network (LAN) or the Internet. For example, the communication control unit 13 controls communication between the camera 20 or the like and the control unit 15.

The storage unit 14 is implemented by a semiconductor memory element such as a random access memory (RAM) or a flash memory, or a storage device such as a hard disk or an optical disc. In the storage unit 14, a processing program for operating the server 10, data to be used during execution of the processing program, and the like are stored in advance or temporarily stored each time processing is performed. Note that the storage unit 14 may be configured to communicate with the control unit 15 via the communication control unit 13.

In the present embodiment, the storage unit 14 stores the position of each camera 20, a model used for processing by an estimation unit 15c to be described later for classifying videos and analyzing the flow of people, and the like.

The control unit 15 is implemented with a central processing unit (CPU) or the like and executes a processing program stored in a memory. Thus, the control unit 15 functions as an identification unit 15a, an acquisition unit 15b, and the estimation unit 15c as illustrated in FIG. 2. Note that each or some of these functional units may be implemented in different pieces of hardware. The control unit 15 may include other functional units.

The identification unit 15a identifies a person to be tracked. Specifically, the identification unit 15a identifies a person to be tracked that satisfies a predetermined condition in a video captured by the camera 20. For example, the identification unit 15a collates a person in a video captured by the camera 20 with a query image of a person desired to be tracked, thereby identifying the person to be tracked.

The estimation unit 15c to be described later estimates a camera 20 that is imaging the identified person, and instructs the camera 20 to start tracking processing. Furthermore, the estimation unit 15c instructs the other cameras 20 to stop the tracking processing.

At least at a first time point, the acquisition unit 15b acquires information regarding movement of a predetermined subject imaged by a first camera 20 among the cameras 20 on the edge. Specifically, when a person identified by the identification unit 15a is being imaged, the acquisition unit 15b acquires the speed and the estimated traveling direction of the person from the camera 20 estimated by the estimation unit 15c. In addition, the acquisition unit 15b acquires a video of the person to be tracked. For example, the acquisition unit 15b acquires information regarding movement when the subject to be tracked moves out of the imaging range of the camera 20 that is tracking the subject.

The estimation unit 15c estimates, from the acquired information regarding movement, a second camera 20 that images the predetermined subject at a second time point later than the first time point on the basis of a movement destination of the predetermined subject. Specifically, when the predetermined subject moves out of the imaging range of the first camera 20, the estimation unit 15c estimates the second camera 20 on the basis of the estimated movement destination of the predetermined subject. That is, when the camera 20 that is tracking the predetermined subject notifies the estimation unit 15c that the subject to be tracked has moved out of the imaging range of the camera, the estimation unit 15c estimates the movement destination of the subject, and estimates the second camera 20 that can image the subject at the movement destination.

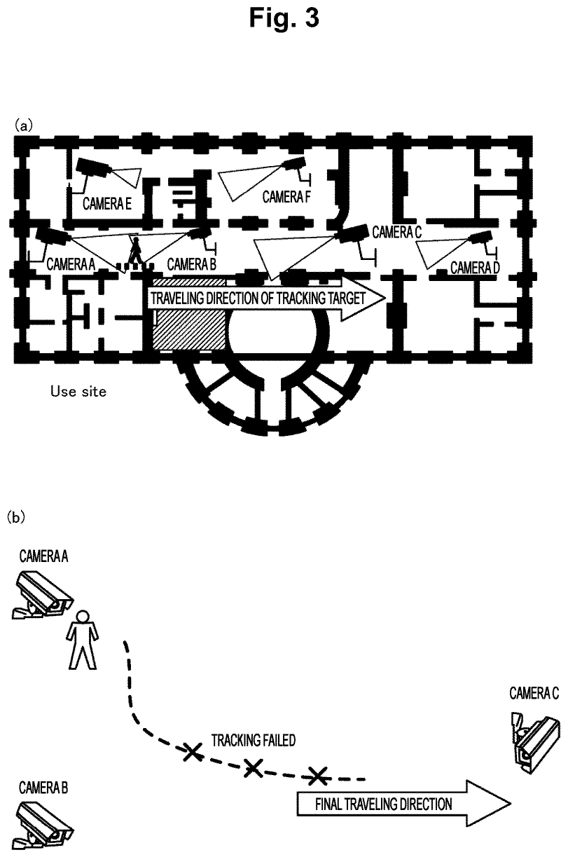

Here, FIG. 3 is a diagram for illustrating processing by the estimation unit. For example, the estimation unit 15c estimates the second camera 20 by using the direction and speed of movement of a predetermined subject as information regarding movement. Specifically, as illustrated in FIG. 3(a), the next camera 20 that can image the subject is estimated on the basis of the speed and the traveling direction of the subject acquired from the first camera 20. In the example illustrated in FIG. 3(a), the estimation unit 15c grasps that the person to be tracked is moving at 80 m/min toward the right from the imaging range of a camera A, and estimates the camera A and cameras B and C as possibilities for the second camera 20 that can image the subject for the next 5 minutes, for example.

Alternatively, the estimation unit 15c estimates the second camera by using a probability distribution of movement patterns of the predetermined subject as illustrated in FIG. 3(b) in addition to or instead of information regarding movement acquired by the acquisition unit 15b. For example, the estimation unit 15c estimates the movement destination of the subject by analyzing accumulated movement patterns of the subject between the cameras 20. That is, for example, the estimation unit 15c analyzes a movement pattern in which 90% of persons who have passed through the imaging range of the camera A move in the direction of the camera C in FIG. 3(b), thereby estimating the camera C as the second camera 20. At that time, the estimation unit 15c uses, for example, a model obtained as a result of the analysis to estimate the movement destination of the subject, thereby estimating the second camera 20.

In a case where it is not known which of the imaging ranges of the cameras 20 the person to be tracked is in when tracking processing is started, the acquisition unit 15b acquires videos captured by the cameras 20, the identification unit 15a collates the person to be tracked, and the estimation unit 15c estimates a camera 20 that can image the estimated movement destination. Then, the estimation unit 15c instructs the estimated camera 20 to start tracking processing, and instructs the other cameras 20 to stop tracking processing.

In this manner, the inference system 1 can efficiently perform desired inference such as tracking of a subject such as a desired person by reducing the data transmission amount and the total computation amount of inference processing with two layers, an edge layer and a cloud layer, by narrowing down necessary processing targets instead of always targeting all the cameras 20.

### Inference Processing

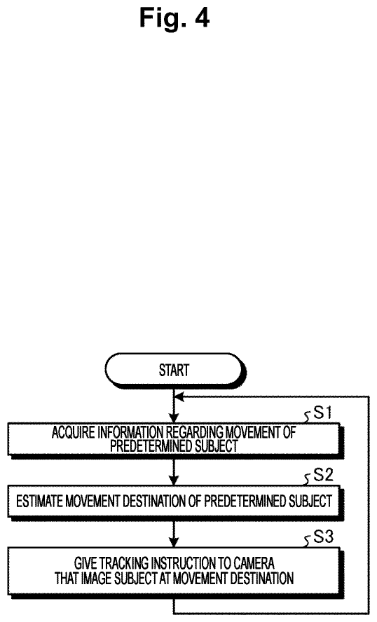

Next, inference processing performed by the inference system 1 according to the present embodiment will be described with reference to FIG. 4. FIG. 4 is a flowchart illustrating an inference processing procedure. The flowchart in FIG. 4 is started at, for example, a timing when a user performs an operation input for a start instruction.

In the server 10, first, the acquisition unit 15b acquires videos from all the cameras 20, the identification unit 15a collates a person to be tracked, and the estimation unit 15c estimates a camera 20 that can image an estimated movement destination. Then, the estimation unit 15c instructs the estimated camera 20 to start tracking processing, and instructs the other cameras 20 to stop tracking processing.

Then, the acquisition unit 15b acquires information regarding movement of the person to be tracked (step S1). For example, when the subject to be tracked moves out of the imaging range of the camera 20 that is performing the tracking, the acquisition unit 15b acquires, from the camera 20, the speed and the estimated traveling direction of the person. At that time, the acquisition unit 15b acquires, from the camera 20, a camera ID for identifying the camera and a rectangle ID of the subject.

Next, the estimation unit 15c estimates the movement destination of the subject (step S2). For example, the estimation unit 15c uses the direction and speed of movement of a predetermined subject to estimate the movement destination of the subject. Alternatively, the estimation unit 15c uses a probability distribution of movement patterns of the predetermined subject to estimate the movement destination of the subject.

Then, the estimation unit 15c estimates, on the basis of information indicating the positions of the cameras 20, a camera 20 that can image the subject at the movement destination (step S3), and instructs the camera 20 to start processing of tracking the subject. The acquisition unit 15b acquires collation data for identifying which camera 20 the person to be tracked is located at, the identification unit 15a collates the person to be tracked, and the estimation unit 15c estimates a camera 20 that is imaging the identified person and instructs the camera 20 to start tracking processing. Furthermore, the estimation unit 15c instructs the other cameras 20 to stop the tracking processing. Thereafter, the estimation unit 15c returns the processing to step S1. In this manner, a series of inference processing is repeated until an instruction to end the subject tracking is given.

### Effects

As described above, in the inference system 1 of the present embodiment, the acquisition unit 15b acquires information regarding movement of a predetermined subject imaged by a first camera 20 among the cameras 20 on the edge at least at a first time point. The estimation unit 15c estimates a second camera 20 that images the predetermined subject at a second time point later than the first time point on the basis of a movement destination of the predetermined subject.

Specifically, when the predetermined subject moves out of the imaging range of the first camera, the estimation unit 15c estimates the second camera.

Thus, in the inference system 1, only the first camera 20 tracks the predetermined subject in the imaging range of the first camera 20. Furthermore, when the subject moves out of the imaging range of the first camera 20, the second camera 20 that can image the subject is estimated, and only the second camera 20 performs tracking. This allows the inference system 1 to efficiently track a desired person. In this manner, the inference system can efficiently perform desired inference and track a subject by reducing the data transmission amount and the total computation amount of inference processing with two layers, an edge layer and a cloud layer.

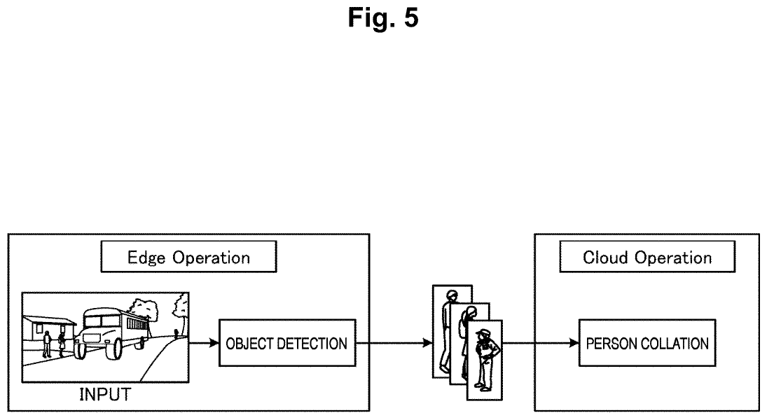

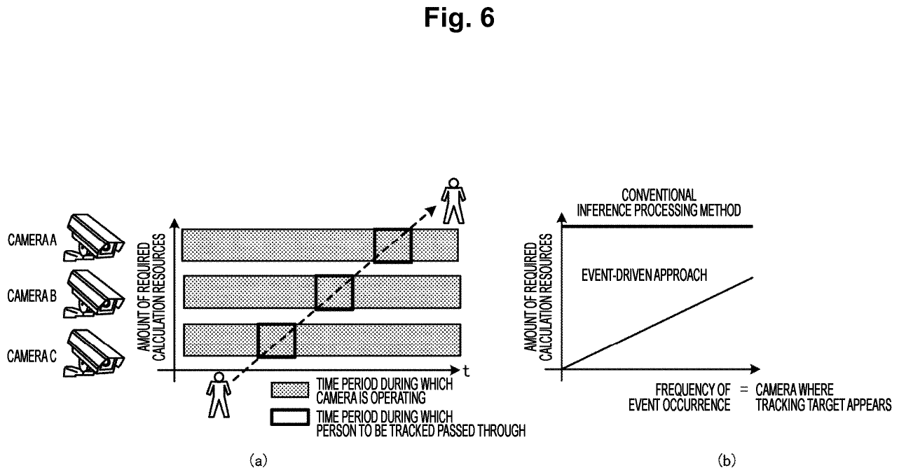

Here, FIGS. 5 and 6 are diagrams for illustrating an effect of the inference processing. In conventional person tracking by inference with two layers, an edge layer and a cloud layer, videos from all the cameras on the edge (or videos of cutout areas including a subject) have been transmitted to the cloud side as illustrated in FIG. 5.

Thus, in the conventional approach, even in a case where a person to be tracked is passing through the imaging ranges of some of a plurality of cameras as illustrated by thick frames in FIG. 6(a), all the cameras 20 (cameras A to C) have continuously kept acquiring videos, and detection and collation of the person to be tracked have been performed on a frame-by-frame basis for all the persons imaged by the cameras. Therefore, as illustrated in FIG. 6(a), a certain amount of calculation resources has continued to be consumed in all the cameras A to C.

On the other hand, in the inference system 1 of the present embodiment, in each camera 20, the amount of required calculation resources increases or decreases in accordance with the frequency of occurrence of an event in which a person desired to be tracked appears in the imaging range as illustrated in FIG. 6(b). Therefore, the amount of required calculation resources for the camera can be reduced as long as the person to be tracked does not appear in the imaging range. Furthermore, the cameras 20 perform only lightweight processing with a small amount of calculation in the first place. Therefore, the inference system 1 of the present embodiment can reduce the amount of required calculation resources and efficiently perform inference processing.

Specifically, the estimation unit 15c estimates the second camera 20 by using the direction and speed of movement of a predetermined subject as information regarding movement. This allows the inference system 1 to efficiently perform inference processing by causing only the camera 20 that can image the subject to track the subject by using information regarding the direction and speed of movement of the subject acquired from the cameras 20 on the edge.

Alternatively, the estimation unit 15c estimates the second camera 20 by using a probability distribution of movement patterns of the predetermined subject in addition to or instead of acquired information regarding movement. This allows the inference system 1 to obtain information regarding movement with high accuracy and perform tracking processing in a case where highly accurate information regarding movement cannot be obtained from the cameras 20 on the edge.

### Program

It is also possible to create a program in which the processing to be executed by the server 10 or the cameras 20 according to the above embodiment is described in a language that can be executed by a computer. As an embodiment, it is possible to implement the server 10 or the cameras 20 by installing, on a desired computer, an inference program for executing the above inference processing as package software or online software. It is possible to cause, for example, an information processing device to execute the above inference program, thereby causing the information processing device to function as the server 10 or the cameras 20. The information processing device described here includes a desktop or notebook personal computer. In addition, the information processing device also includes a mobile communication terminal such as a smartphone, a mobile phone, or a personal handyphone system (PHS), a slate terminal such as a personal digital assistant (PDA), and the like. Furthermore, the function of the server 10 or the cameras 20 may be implemented in a cloud server.

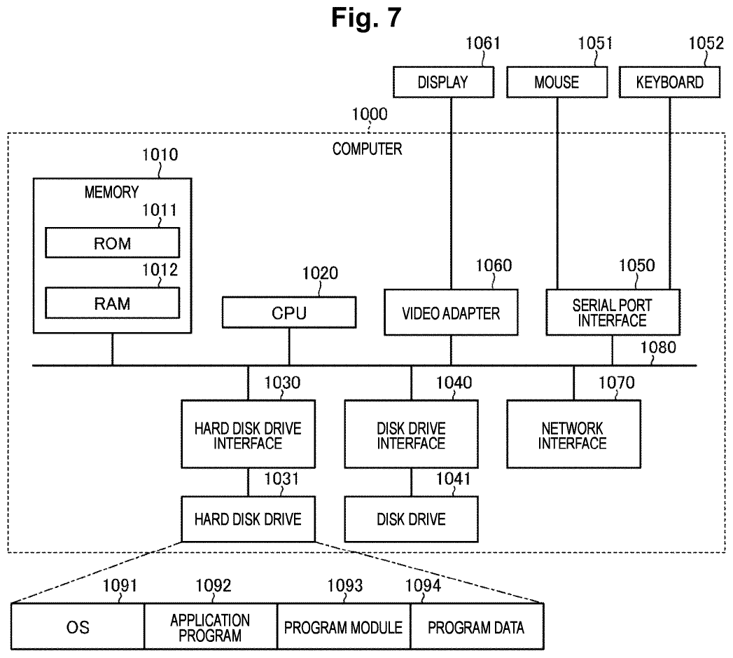

FIG. 7 is a diagram illustrating an example of a computer that executes an inference program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to, for example, a mouse 1051 and a keyboard 1052. The video adapter 1060 is connected to, for example, a display 1061.

Here, the hard disk drive 1031 stores, for example, an OS 1091, an application program 1092, a program module 1093, and program data 1094. All pieces of the information described in the above embodiment are stored in the hard disk drive 1031 or the memory 1010, for example.

The inference program is stored in the hard disk drive 1031 as the program module 1093 in which commands to be executed by the computer 1000, for example, are described. Specifically, the program module 1093 in which each piece of the processing to be executed by the server 10 or the cameras 20 described in the above embodiment is described is stored in the hard disk drive 1031.

Data used for information processing performed by the inference program is stored as the program data 1094 in the hard disk drive 1031, for example. The CPU 1020 reads, into the RAM 1012, the program module 1093 and the program data 1094 stored in the hard disk drive 1031 as necessary and executes each procedure described above.

The program module 1093 and the program data 1094 related to the inference program are not limited to being stored in the hard disk drive 1031, and may be stored in, for example, a removable storage medium and read by the CPU 1020 via the disk drive 1041 or the like. Alternatively, the program module 1093 and the program data 1094 related to the inference program may be stored in another computer connected via a network such as a LAN or a wide area network (WAN), and may be read by the CPU 1020 via the network interface 1070.

Although the embodiment to which the invention made by the present inventors is applied has been described above, the present invention is not limited by the description and the drawings constituting a part of the disclosure of the present invention according to the present embodiment. That is, other embodiments, examples, operation technologies, and the like made by those skilled in the art and the like on the basis of the present embodiment are all included in the scope of the present invention.

### REFERENCE SIGNS LIST

10 Server
13, 23 Communication control unit
14, 24 Storage unit
15, 25 Control unit
15a Identification unit
15b Acquisition unit
15c Estimation unit
20 Camera
22 Imaging unit
25a Detection unit
25b Tracking unit

1. An inference method, comprising:
acquiring information regarding movement of a predetermined subject imaged by a first camera among cameras on the edge at least at a first time point; and
estimating a second camera that images the predetermined subject at a second time point later than the first time point on a basis of a movement destination of the predetermined subject.

2. The inference method according to claim 1, wherein:
the estimating includes estimating the second camera when the predetermined subject moves out of an imaging range of the first camera.

3. The inference method according to claim 1, wherein:
the estimating includes estimating the second camera by using a direction and speed of movement of the predetermined subject as the information regarding movement.

4. The inference method according to claim 1, wherein:
the estimating includes estimating the second camera by using a probability distribution of movement patterns of the predetermined subject in addition to or instead of the information regarding movement.

5. An inference system including an edge and a server, the inference system comprising:
acquisition circuitry that acquires information regarding movement of a predetermined subject imaged by a first camera among cameras on the edge at least at a first time point; and
estimation circuitry that estimates a second camera that images the predetermined subject at a second time point later than the first time point on a basis of a movement destination of the predetermined subject.

6. A non-transitory computer readable medium storing an inference program for causing a computer to execute:
acquiring information regarding movement of a predetermined subject imaged by a first camera among cameras on an edge at least at a first time point; and
estimating a second camera that images the predetermined subject at a second time point later than the first time point on a basis of a movement destination of the predetermined subject.
